(19) United States
(12) Patent Application Publication
(10) Pub. No.: US 2013/0078139 A1
(43) Pub. Date: Mar. 28, 2013

(54) CONTROL OF DEFORMATION-INDUCED IMPERFECTIONS TO ENHANCE STRENGTH OF METALS AND ALLOYS

(71) Applicants: Terry C. Lowe, Santa Fe, NM (US); Donald J. Sandstrom, Grants, NM (US)

(72) Inventors: Terry C. Lowe, Santa Fe, NM (US); Donald J. Sandstrom, Grants, NM (US)

(21) Appl. No.: 13/619,835

(22) Filed: Sep. 14, 2012

Related U.S. Application Data
(60) Provisional application No. 61/537,629, filed on Sep. 22, 2011.

(51) Int. Cl. G01N 23/00; G01N 9/00; B21J 5/00; B32B 15/00; B21D 31/00

(52) U.S. Cl. 420/591; 72/377; 72/364; 73/32 R; 250/307

(57) ABSTRACT

The disclosed invention specifies: 1) a metal or alloy with specific characteristics of its Deformation-induced Volumetric Microstructural Imperfections (DIVMI), 2) a method to measure these imperfections, and 3) a method to control these imperfections in a way that enhances one or more of strength, ductility, and the high cycle fatigue endurance limit of metals and alloys. The invention recognizes that all deformation-processed metals or alloys contain DIVMI and that through Severe Plastic Deformation processing one can minimize the characteristics of DIVMI that limit mechanical properties. Application of the methods to measure and control imperfections allows one to produce metals and alloys with strengths approaching the theoretical limit of strength.

This application claims priority to U.S. provisional application 61/537,629, filed Sep. 22, 2011, incorporated herein by reference.

### TECHNICAL FIELD

The present invention relates to metals or alloys with enhanced strength achieved by controlling microstructural imperfections and methods for producing such metals and alloys, such as by thermomechanical processing.

### BACKGROUND

Additional strength can be imparted to most metals and alloys by subjecting them to large permanent deformations, for example by rolling, extrusion, or drawing. Permanent or inelastic deformation causes the generation of microstructural features inside metals and alloys that increase their resistance to additional inelastic deformation. This additional resistance to further inelastic deformation is commonly called strain hardening, work hardening, cold working, or warm working.

There has been particular interest in novel methods to impose very large, or severe, levels of plastic deformation in order to achieve ever higher levels of strength. Producing Bulk Ultrafine-Grained Materials by Severe Plastic Deformation; Ruslan Z. Valiev, Yuri Estrin, Zenji Horita, Terence G. Langdon, Michael J. Zehetbauer, Yuntian T. Zhu. 4, 2006, Journal of Metals, Vol. 58, pp. 33-39. These new methods of deformation processing are collectively referred to as Severe Plastic Deformation (SPD) processing methods when they impart levels of plastic strain εₚ greater than 3 in the presence of large compressive or hydrostatic forces. There are at least 50 variants of these methods that have been disclosed in the academic or patent literature. Status of Commercialization of Nanostructured Metals; Lowe, Terry C. [ed.] R B Figueiredo, T G Langdon J T Wang. Zurich:Trans Tech Publications Ltd, 2011, Vols. 667-669, pp. 1145-1152. ISSN 0255-5476. Each of these methods is designed to impart large plastic deformations that alter the internal microstructure of metals in a manner that enhances strength and other properties. A mechanism commonly cited by which additional strength is achieved during SPD processing of metals and alloys is through the reduction of the size of their constituent crystals, or grains. The grain size that is typically produced by SPD is between 100 nanometers and 1.5 micrometers, approximately 10 to 500 times smaller than the grain size of conventional metals. Principles of equal-channel angular pressing as a processing tool for grain refinement; Ruslan Z. Valiev, Terence G. Langdon; 7, Amsterdam:Elsevier, 2006, Progress in Materials Science, Vol. 51, pp. 881-981. ISSN 0079-6425. Metals with grain size in the range between 100 nm and 1000 nm are said to be ultrafine grained. The effect of grain size on the strength of metals is commonly labeled the Hall-Petch effect, after the authors who explained the phenomena in the 1950s. The Deformation and Ageing of Mild Steel: III Discussion of Results; Hall, E. O. London: Royal Society of London, 1951, Proceedings of the Royal Society of London, Vol. B 64, pp. 747-753. ISSN 0021-1567; Petch, N. J. s.l.: Iron and Steel Institute, 1953, The Journal of the Iron and Steel Institute, Vol. 174, p. 25. Microstructural features other than grain size also influence strength and other properties. For example, additional strength contributions have been associated with the presence of specific characteristics of grain boundaries. Valiev and Langdon (The Art and Science of Tailoring Materials by Nanostructuring for Advanced Properties Using SPD Techniques; R. Z. Valiev, T. G. Langdon. 8, Weinheim: Verlog GmbH & Co., 2010, Vol. 12, pp. 677-691) have introduced a model to describe strength increments due to SPD in terms of four additive factors: strength from the intrinsic threshold stress for inelastic deformation σₒ, plus strength associated with high angle grain boundaries σ_{HAB}, low angle grain boundaries σ_{LAB}, and the nonequilibrium structure of grain boundaries σ_{NGB}. Thus the total strength for plastic yielding _{γ} is given by equation 1:

σ_{y}=σₒ+σ_{HAB}+σ_{LAB}+σ_{NGB} Eqn. 1

While this equation provides a framework for interpreting the increments in strength in SPD processed metals, it does not adequately address contributions to strength not associated with grain boundaries.

The patent literature discloses various methods, apparatuses, and materials that possess ultrafine grain sizes and additional strength, for example, U.S. Pat. Nos. 3,686,041 METHOD OF PRODUCING TITANIUM ALLOYS HAVING AN ULTRAFINE GRAIN SIZE AND PRODUCT PRODUCED THEREBY (1972), 4,021,271 ULTRAFINE GRAIN AL-MG ALLOY PRODUCT (1977), 5,400,633 APPARATUS AND METHOD FOR DEFORMATION PROCESSING OF METALS, CERAMICS, PLASTICS AND OTHER MATERIALS (1995), 6,197,129 METHOD FOR PRODUCING ULTRAFINE-GRAINED MATERIALS USING REPETITIVE CORRUGATION AND STRAIGHTENING, 6,399,215 ULTRAFINE-GRAINED TITANIUM FOR MEDICAL IMPLANTS (2002), 7,785,530 METHOD FOR PREPARING ULTRA-FINE, SUBMICRON GRAIN TITANIUM AND TITANIUM-ALLOY ARTICLES AND ARTICLES PREPARED THEREBY (2010), and 7,736,448 NANOCRYSTALS COPPER MATERIAL WITH SUPER HIGH STRENGTH AND CONDUCTIVITY AND METHOD OF PREPARING THEREOF (2010).

These patents associate their claims of deformation-induced strength mainly with grain size reduction. Other microstructural features resulting from deformation have also been associated with strength enhancement, for example increased density of twins or dislocations. Mechanical properties of nanocrystalline materials; M. A. Meyers, A. Mishra, D. J. Benson. Amsterdam:Elsevier, 2006, Progress in Materials Science, Vol. 51, pp. 427-556. These additional features are additive, though not necessarily independent, in their effects on the strength of metals and alloys. The prior art dwells persistently on the microstructural characteristics that add to strength to metals and alloys. This mentality underlies the deformation-induced strengthening increments in the range of 10%-300% that have been reported. The Deformation Physics of Nanocrystalline Metals: Experiments and Computations; Marc A. Meyers, Anuj Mishra, David J. Benson; s.l.: The Metallurgical Society, 2006, pp. 41-48.

The approach of developing deformation methods to strengthen metals of alloys through grain size refinement is valid for the 10%-300% increments in strength that have been reported to date. However, this mentality breaks starts to break down at and beyond the largest of currently reported increments in strength. Various point defects (e.g. vacancies, solutes), line defects (e.g. dislocations, disclinations), and planar defects (e.g. twins, grain boundaries) provide strength by blocking the motion of dislocations or localized shear by the formation of twins. However, as the strength achieved in metals and alloys increases toward the theoretical limit of maximum strength (Shear deformation, ideal strength, and stacking fault formation of fcc metals: A density-functional study of Al and Cu; Michal Jahnatek, Jurgen Hafner, Marian Krajci; 22, 2009, Physical Review B, Vol. 79, pp. 224103-1-16), imperfections in the perfect crystal lattice change roles from providing strength to becoming the features that nucleate fracture or other failure modes, and thereby limit further increases in strength. Weertman and coworkers (P. G. Sanders, J. A. Eastman, J. R. Weertman; s.l.: Acta Materialia, 1997, Vol. 45; S. R. Agnew, J. R. Weertman; 2000, Materials Science and Engineering A, Vol. 285, p. 391) have shown that for palladium and copper with very small grain sizes (less than 50 nm) that the uncontrolled presence of defects limits, rather than enhances strength. Nanometer or micrometer scale defects may exceed the critical sizes above which one observes tensile instability, fracture, or fatigue crack growth. The classic equation for fracture initiation based on stress intensity factor K_{IC} teaches us that the critical flaw size a_{c} decreases with the square of the inverse of the critical stress σ_{c}

$${a}_{c} = A \frac{1}{π} {( \frac{{K}_{IC}}{{δ}_{c}} )}^{2} , \qquad Eqn . 2$$

where A is a dimensionless constant. Thus as metals become stronger, the tolerance for flaws diminishes. According to Equation 2, as the stress σ_{c} within a material increases, the critical flaw size for fracture a_{c} decreases. Thus, metals subject to SPD that may possess strength levels several times greater than conventionally processed metals (The Deformation Physics of Nanocrystalline Metals: Experiments and Computations; Marc A. Meyers, Anuj Mishra, David J. Benson; s.l.: The Metallurgical Society, 2006, pp. 41-48) are therefore less tolerant of flaws, including volumetric microstructural defects such as voids. Furthermore, one finds that microscale and macroscale variations in residual internal stresses in severely deformed metals further increase the maximum levels of internal stresses present beyond the applied stress, and therefore further reduces the critical flaw size for failure during loading. High Tensile Strength of Low-Carbon Ferritic Steel Subjected to Severe Drawing; Tetsuya Suzuki, Yo Tomota, Atsushi Moriai, Hitoshi Tashiro; 1, s.l.: The Japan Institute of Metals, 2009, Materials Transactions, Vol. 50, pp. 51-55; Low-temperature deformation and fracture of bulk nanostructured titanium obtained by intense plastic deformation using equal channel angular pressing; V. Z. Bengus, E. D. Tabachnikova, V. D. Natsik, I. Mishkuf, K. Chakh, V. V. Stolyarov, R. Z. Valiev; 11, November 2002, Low Temperature Physics, Vol. 28, pp. 864-874.

One of the most pervasive indicators of the role of flaws in limiting the properties of SPD processed metals is their poor high cycle fatigue performance. The results of studies of fatigue in SPD processed metals consistently show that improvements in the high cycle fatigue endurance limit are modest compared to the improvements in tensile strength. Cyclic deformation and fatigue properties of very fine-grained metals and alloys; Hael Mughrabi, Heinz Werner Hoppel; 9, Amsterdam:Elsevier, 2010, International Journal of Fatigue, Vol. 32, pp. 1413-1427. Fatigue cracks initiate around critical sized flaws that may otherwise have only small effects upon tensile properties. Cyclic loading provides a particularly sensitive means to detect the presence of inhomogeneities and imperfections in metals and alloys.

Another indicator of the flaw intolerance of SPD processed metals is the tendency for breakage of test samples even when carefully prepared according to international standards for tensile strength testing such as American Society for Testing Materials International (ASTM) standard E8-03. Typically between 15% and 60% of a batch of samples subject to tensile testing fails in the volume of metal that is within the loading grips rather than in the reduced diameter gauge section. This is also observed in high cycle fatigue testing of SPD-processed metal samples per ASTM Standard E466. Failure occurs within the volume of metal underneath the grips because of the combined effects of the presence of critical sized flaws there and elastic stress concentration that can be caused by gripping very high strength metals.

### SUMMARY OF INVENTION

While the approach of using deformation to work harden metals and alloys by reducing grain size and by the introduction of additional microstructural defects is effective for increasing strength, this is valid only up to a point. The present invention recognizes that to achieve the highest levels of mechanical properties, including ever higher strength levels, it is necessary to control the density and size of microscale and nanoscale imperfections that limit strength. FIG. 1 illustrates schematically the domains of strength-enhanced (imperfection enhanced properties) and strength-limiting (imperfection limited properties) microstructural imperfections. It is insufficient to merely add microstructural features that enhance strength without at the same time controlling the presence of one type of microstructural imperfection: volumetric imperfections that may exist at the micrometer scale and the nanometer scale. Volumetric imperfections are perturbations in the normally close packed atomic lattice of metals for which there is a localized variation in the density from the close packed density of the metal matrix. Examples of such imperfections include vacancies, vacancy clusters, voids of any size, dense dislocation walls, and disordered grain boundary regions.

Large increments in strength and fatigue resistance can be imparted via SPD by controlling the density and size of volumetric imperfections during processing. The importance of controlling imperfection size can be quantified by considering an example. Consider that the threshold stress intensity factor range AK for fatigue crack growth in titanium alloys ranges between 4 and 15 MPa√m depending upon the level of internal stresses. Fatigue crack growth behavior of titanium alloys; K. Sadananda, A. K. Vasudevan; 10, Amsterdam:Elsevier, 2005, International Journal of Fatigue, Vol. 27, pp. 1255-1266. At these stress intensity factor levels the critical flaw size according to Equation 2 for allowing crack growth in metal with tensile strength over 1.3 GPa is on the order of 1 micrometer. As will be described later, volumetric defects have been measured in this size range in significant concentration in commercial purity titanium, as shown in Table 1. This is also the size range of iron or oxygen-rich inclusions in titanium. Such inclusions or other similar size imperfections have lesser or even negligible impact on failure for lower strength metals and alloys. However, control of such imperfections is important to impart very high strength levels to metals and alloys achievable via SPD processing.

Embodiments of the present invention comprise a metal or alloy object, comprising a rod, sheet, bar, plate, wire, or other shape which has been produced using severe plastic deformation processing to reduce the density of volumetric deformation induced microstructural imperfections. In some embodiments, the maximum size, average size, or both, of deformation-induced volumetric microstructural imperfections is shifted to smaller values. In some embodiments, the ratio of the maximum to minimum linear dimensions deformation-induced volumetric microstructural imperfections is maintained or shifted toward unity (1). In some embodiments, spatial gradients in the density of deformation-induced volumetric microstructural imperfections are maintained or shifted to correspond with gradients in the density of non-volumetric deformation induced microstructural imperfections. In some embodiments, spatial gradients in the density of deformation-induced volumetric microstructural imperfections are maintained or shifted to not be steeper than gradients in the density of non-volumetric deformation induced microstructural imperfections. In some embodiments, spatial gradients in the size distribution of deformation-induced volumetric microstructural imperfections are maintained or shifted to not be steeper than gradients in the density of non-volumetric deformation induced microstructural imperfections. In some embodiments, spatial gradients in the asymmetry of shape of deformation-induced volumetric microstructural imperfections, that is, the ratio of maximum to minimum linear dimensions, are maintained or shifted to not be steeper than gradients in the density of non-volumetric deformation induced microstructural imperfections.

Embodiments of the present invention comprise a method to improve the strength of metals and alloys comprising measuring the density and size distribution of deformation-induced volumetric microstructural imperfections and determining processing parameters based on such measurements. In some embodiments, the measurement technique includes the use of Small Angle Neutron Scattering. In some embodiments, the measurement technique includes Neutron Tomography. In some embodiments, the measurement technique includes the use of Small Angle X-ray Scattering. In some embodiments, the measurement technique includes X-Ray Micro-tomography. In some embodiments, the measurement technique includes Nanoscale X-Ray Tomography. In some embodiments, the measurement technique includes X-Ray Coherent Diffraction Imaging (XCDI). In some embodiments, the measurement technique includes Electron Coherent Diffraction Imaging (ECDI). In some embodiments, the measurement technique includes the use of Positron Lifetime Spectroscopy. In some embodiments, the measurement technique includes Positron Emission Tomography. In some embodiments, the measurement technique includes the use of electron microscopy imaging. In some embodiments, the measurement technique includes Electron Microscopy Tomography. In some embodiments, the measurement technique includes Atomic Probe Tomography.

Embodiments of the present invention comprise a method to improve the strength of metals and alloys by controlling the density and size distribution of deformation-induced volumetric microstructural imperfections. In some embodiments, the size distribution of deformation-induced volumetric microstructural imperfections is maintained or shifted to smaller sizes. In some embodiments, the temperature and rate of severe plastic deformation are specified to minimize the density of deformation-induced volumetric microstructural imperfections. In some embodiments, imperfection control is achieved through implementation of specific features in the design of the apparatus for SPD processing to maximize the intensity of localized shearing, with features that include deformation schema and die characteristics that maximize shearing. In some embodiments, the method can comprise Equal Channel Angular Pressing, using die angles of 90 degrees or more, with zero radius of curvature inner and outer radii at channel intersections. In some embodiments, a specific combination of thermomechanical processing steps and parameters are utilized, guided by criteria that cause the reduction of the density and size of deformation-induced volumetric imperfections. In some embodiments, the quantitative measurements of imperfection density and size distribution are employed to measure or verify processing results, including, but not limited to one or more of the following techniques: Small Angle Neutron Scattering (SANS), Ultra Small Angle Neutron Scattering (USANS), Small Angle X-ray Scattering (SAXS), Ultra Small Angle X-ray Scattering (USAXS), Neutron Tomography, Positron Lifetime Spectroscopy, X-ray Profile Analysis (XPA), Multi Reflection Multi-line X-ray Profile Analysis (MXPA), Residual Electrical Resistometry (RER), Electron Microscopy (EM), X-Ray Micro-tomography, Nanoscale X-Ray Tomography, X-Ray Coherent Diffraction Imaging (XCDI), Electron Coherent Diffraction Imaging (ECDI), Electron Microscopy Tomography.

### DESCRIPTION OF DRAWINGS

The accompanying figures are incorporated into and form part of the specification, and, with the specification, illustrate example embodiments of the present invention.

FIG. 1 is a schematic showing the distinction between the conceptual approach in the prior art (imperfection enhanced properties) and the present invention (imperfection limited properties) for achieving the highest possible strength in metals and alloys through deliberate control of property-limiting imperfections. In the lower strength regime imperfections mainly enhance strength, while in the upper regime imperfections limit strength.

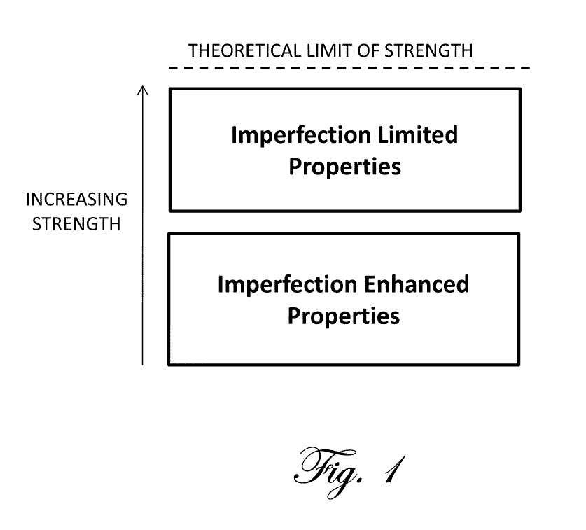

FIG. 2 is a schematic illustration of four sequential steps of a method for selecting thermomechanical processing parameters to produce high strength metals and alloys. The 4^{th} step can be repeated for every stage of a multi-stage thermomechanical process.

FIG. 3 is a schematic illustration of intense shear changing an initially spherical void 307 (a) into an ellipsoidal shape 308 (b) that can more readily collapse under compressive stress 309 (c) or be subdivided by subsequent intense shearing following reorientation 310 out of the original shearing plane (d) to create smaller free volumes 311 (e).

FIG. 4 is an illustration of Ultra Small Angle Neutron Scattering measurements of volumetric imperfection size distributions in commercial purity Grade 2 titanium: (a) as-received (D2-AR), (b) after ECAP (D2-E). The imperfection density and average size decrease after ECAP.

FIG. 5 is an illustration of Ultra Small Angle Neutron Scattering measurements of volumetric imperfection size distributions in commercial purity Grade 2 titanium after ECAP and 74% reduction via drawing. The imperfection density increases and average imperfection size decreases. FIG. 5 shows the results of measurements of the density and size distribution of volumetric defects in Grade 2 titanium for two states, after Equal Channel Angular Pressing and after Equal Channel Angular Pressing plus drawing.

FIG. 6 is a scanning electron microscope image of the distribution of iron in ultrafine grained grade 4 titanium. Volumetric imperfections associated with iron range in size between 200 nm and 1100 nm. FIG. 6 confirms the existence of volumetric imperfections resulting from clusters of iron with size in the range of from 200 nm to 1100 nm.

### DETAILED DESCRIPTION OF INVENTION

Embodiments of the present invention provide: 1) one or more metals or alloys with specific characteristics of its Deformation-induced Volumetric Microstructural Imperfections (DIVMI), 2) one or more methods to measure these imperfections, and 3) one or more methods to control these imperfections in a way that enhances one or more of strength, ductility, and the high cycle fatigue endurance limit of metals and alloys. The invention recognizes that all deformation-processed metals or alloys contain DIVMI and that through SPD processing one can minimize the characteristics of DIVMI that limit mechanical properties.

The present invention introduces the technology and methodology to measure and understand how SPD processing impacts the generation of strength-limiting imperfections. It thus enables one to design new metals or alloys and SPD processes by which they can be manufactured.

To implement the invention disclosed herein, one must replace the model for the strength level at which inelastic yielding occurs in metals in the prior art, as represented by Equation 2, to instead contain the following four components:

σ_{y}=σₒ+σ_{NDIMI}+σ_{DINVMI}+σ_{DIVMI} Eqn. 3

where σₒ is the intrinsic threshold stress for inelastic deformation, σ_{NDIMI} is the intrinsic strength component associated with Non-Deformation-induced Microstructural Imperfections (NDIMI), σ_{DINVMI} a is the strength component associated with Deformation-induced Non-Volumetric Microstructural Imperfections (DINVMI), and σ_{DIVMI} is the strength component associated with Deformation-induced Volumetric Microstructural Imperfections (DIVMI). Both σₒ and σ_{NDIMI} represent intrinsic strength contributions that are independent of inelastic deformations imposed during thermomechanical processing of metals. σ_{NDIMI} includes strengthening contributions due to the presence of solutes, second phases, precipitates, dispersoids, and initial grain boundaries. In contrast, σ_{DINVMI} a σ_{DIVMI} represent the strengthening contributions of deformation-induced imperfections. These two strength contributions differentiate the effects of non-volumetric and volumetric imperfections. Making this distinction is critical for specifying thermomechanical inelastic deformation processing steps to optimize high strength. Non-volumetric imperfections include twins, individual dislocations and dislocation loops, dislocation tangles and loose boundaries. Volumetric imperfections include vacancies, vacancy clusters, voids, dense dislocation walls, and disordered and non-equilibrium grain boundaries. Each of the strength components in Equation 3 can be further divided into specific subcomponents associated with each of the distinct microstructural features on which they depend. For example, one can represent σ_{DIVMI} as:

σ_{DIVMI}=σ_{VC}+σ_{VOID}+σ_{DDW}+σ_{NGB} Eqn. 4

where σ_{VC}, σ_{VOID}, σ_{DDW}, and σ_{NGB} are the contributions to strength due to, respectively, vacancy/vacancy clusters, voids, dense dislocation walls, and non-equilibrium/disordered grain boundaries. For the purpose of the present invention, the finer level of differentiation of strength components represented in Equation 4 is not necessary, except to show the relationship between this invention and the prior art. Note that σ_{NGB} from Equation 2 is just one component contributing to σ_{DIVMI} in Equation 3. Similarly, σ_{LAB} and σ_{HAB} from Equation 2 are two components that contribute to σ_{DINVMI} in Equation 3. Thus equation 3 fully encompasses and extends the prior art represented in Equation 2. In this invention, it matters that we distinguish volumetric and non-volumetric imperfections. This is because the volumetric imperfections have the dual role of providing strength on one hand, but also being the initiation sites for fracture and fatigue crack initiation. In general, deformation-induced volumetric imperfections have a small effect upon increments of deformation-induced strength compared to the magnitude of effect of non-volumetric imperfections. However, the volumetric imperfections have a significant effect in very high strength metals and alloys: they are the critical size flaws leading to fracture or serving as initiation sites for the nucleation of fatigue cracks. Thus they can limit the maximum achievable mechanical properties.

The characteristics of deformation-induced volumetric microstructural imperfections in metals and alloys to be measured and controlled according to the present invention include without limitation:

1) the density of DIVMI,
2) the size distribution of DIVMI,
3) shape of DIVMI, and
4) spatial distribution and gradients of density, size, and shape of DIVMI.
The values for these four attributes that can be sought to maximize strength in deformation-processed metal or alloys are as follows:
1) low density of DIVMI (<5×10⁻⁴),
2) small maximum radius (<1 μm) and average radius (<180 nm) of DIVMI
3) isotropic DIVMI (ratio of minimum/maximum linear dimensions >0.5), and
4) spatial gradients in DIVMI density, size, and shape not steeper than spatial gradients in Deformation-induced Non-volumetric Imperfections (DINVMI).

The first two microstructural characteristics, density and size distribution of DIVMI can be of primary importance, while the second two characteristics, shape and gradients of DIVMI, can be of secondary importance. Therefore, quantitative knowledge of the density and size distribution function Ø_{VMI} for nanometer scale and micrometer scale volumetric microstructural imperfections in SPD-processed metals can be important to implement the present invention and achieve desirable values of these microstructural characteristics. Ø_{VMI} includes two components: the density and size distribution functions for deformation-induced volumetric microstructural imperfections, Ø_{DIVMI}, and non-deformation-induced volumetric microstructural imperfections, Ø_{NDIVMI}, which combine linearly as given in Equation 5.

Ø_{VMI}=Ø_{NDIVMI}+Ø_{DIVMI} Eqn. 5

There are several measurement techniques that are available to quantify Ø_{VMI} in the range from 1 nm to 10,000 nm. To quantify the density of Ø_{VMI} at the low end of this size range, less than 100 nm, X-ray Profile Analysis (XPA), Multi Reflection Multi-line X-ray Profile Analysis (MXPA), Small Angle X-ray Scattering (SAXS), Ultra Small Angle X-ray Scattering (USAXS), Positron Lifetime Spectroscopy (PLS), and Electron Microscopy (EM)), and Electron Microscopy Tomography (EMT). PLS can provide detailed quantitative information for the smallest size defects. However, PLS measurements are limited to the diffusion length of positrons, typically less than 100 nm, so that the technique probes only a very small volume of metal. Additional techniques that can be applied to bulk samples such as Residual Electrical Resistometry (RER), Differential Scanning calorimetry (DSC) have been used to determine imperfection densities, though these techniques provide no information about imperfection size distributions. When these techniques have been applied to SPD-processed metals they have shown that SPD can induce high concentrations of vacancies and vacancy clusters. Structural investigations of submicrocrystalline metals obtained by high-pressure torsion deformation; R. Kuzel, Z. Matej, V. Cherkaska, J. Pesicka, J. Cizek, I. Prochazka, R. K. Islamgaliev; s.l.: Elsevier, 2004, Journal of Alloys and Compounds, Vol. 378, pp. 242-247; Lattice defect investigation of ECAP-Cu by means of X-ray line profile analysis, calorimetry and electrical resitometry; E. Schafler, G. Steiner, E. Korznikova, M. J. Zehetbauer; Amsterdam:Elsevier, 2005, Materials Science and Engineering A, Vols. 410-411, pp. 169-173; Vacancy production during plastic deformation in copper determined by in situ X-ray diffraction; Tamas Ungar, Erhard Schafler, Peter Hanak, Sigrid Bernstorff, Michael Zehetbauer; 1-2, Amsterdam:Elsevier, 2007, Materials Science and Engineering A, Vol. 462, pp. 398-401. PLS measurements have shown densities of nanoscale voids as high as 10⁻⁴ with vacancy cluster sizes between 4 to 40 vacancies resulting from SPD processing of nickel and copper. These concentrations are 2 to 3 times higher than reported for conventionally deformed metals, for example, produced by rolling. Direct imaging using electron microscopy (EM) used in conjunction with quantitative image analysis techniques can also be applied. However, this method can be affected by sample preparation to reveal a surface to image, causing changes in imperfections. Also, for very low concentrations of imperfections this technique can require scanning large areas. For resolution and quantitative measurement of features in the size range between 100 nm and 10,000 nm X-ray Micro-Tomography (XMT), X-ray Nanoscale Tomography (XNT), X-Ray Coherent Diffraction Imaging (XCDI), Electron Coherent Diffraction Imaging (ECDI), Neutron Tomography (NT), and Positron Tomography (PT) are more appropriate.

Small Angle Neutron Scattering (SANS) and Ultra Small Angle Neutron Scattering (USANS) can non-destructively quantify Ø_{VMI} over the entire range of importance for metals and alloys. SANS allows the measurement of the density and size distribution of volumetric perturbations with sizes between 1 nanometer and 100 nanometers (Pore Distributions in Nanocrystalline Metals from Samll-Angle Neutron Scattering; P. G. Sanders, J. A. Eastman, J. R. Weertman; 12, s.l.: Elsevier, 1998, Acta Metallurgica, Vol. 46, pp. 4195-4202), within sampling volumes in most metals on the order of 2 to 20 cubic millimeters. USANS extends the range of detection to larger sizes, beyond 1 micrometer. Thus, SANS/USANS can detect porosity, voids, vacancy clusters, and virtually any imperfection in a size range between 1 nm and several micrometers within bulk sized samples which causes a 3% or greater variation in density in a metal matrix. Furthermore, the SANS/USANS measurement techniques are unperturbed by any artifacts of sample preparation that can affect other characterization techniques such as electron microscopy. SANS/USANS measurements of Ø_{VMI} both before and after thermomechanical processing are needed to distinguish the density and size distribution functions for deformation induced imperfections Ø_{DIVMI} from non-deformation-induced imperfections Ø_{NDIVMI}. SANS can detect the shape of DIVMI and by using neutron beam collimation, can also measure spatial gradients. Thus SANS/USANS is capable of characterizing all four of characteristics of DIVMI that contribute to limitations of strength.

The use of these characterization methods individually or collectively to quantify the density and size distribution of volumetric imperfections is part of the method disclosed herein for enhancing the strength of metals and alloys.

An aspect of the present invention can be understood as maximizing Ø_{DINVMI} from Equation 3 while minimizing Ø_{DINVMI} from Equation 5. In contrast to the prior art, in which improvements in strength are associated with grain size and grain boundary characteristics as represented in Equation 2, the presence of free volume associated with DIVMI can be a more universal parameter to measure and control achieve maximum strength. Note that ultrafine grain sizes, high dislocation densities, and high fractions of high angle grain boundaries are ubiquitous features of metals and alloys processed by SPD in the art. Kurzydlowski, K. J. and Lewandowska, Malgorzata; Fabrication of Nanostructured Materials by Hydrostatic Extrusion Advantages and Limitations; www.scientific.net; [Online] 2007; 194.29.176.242-Mar. 10, 2007. Their contributions to strength and other properties are described extensively in over 4500 publications in the archival academic literature between 1990 and 2010 on ultrafine grain materials and severe plastic deformation processing. For example, it is openly published and understood that the fraction of high angle grain boundaries produced by all five of the leading SPD processing methods is greater than 60%. Kurzydlowski, K. J. and Lewandowska, Malgorzata; Fabrication of Nanostructured Materials by Hydrostatic Extrusion: Advantages and Limitations; www.scientific.net; [Online] 2007; 194.29.176.242-Mar. 10, 2007. However, the improvements due to these microstructures saturate. Additional deformation does not produce additional grain refinement or changes in strength. Even the strengthening effect of reducing grain size is exhausted, as exemplified by the inverse Hall-Petch effect that exists in metals as grain sizes decreases below 100 nm. Takeuchi, S.; The mechanism of the inverse Hall-Petch effect of nanocrystals; 2001. pp. 1483-1487. Vol. 44.

Heretofore, none of the various SPD methods or apparatuses have been designed to optimize the density and size distribution of volumetric microstructural imperfections. This invention encompasses metals and alloys with both a reduced Ø_{VMI} and enhanced Ø_{DINVMI}, methods to measure Ø_{VMI}, and the means to apply this knowledge to design one or more SPD processes to reproducibly manufacture high strength metals and alloys.

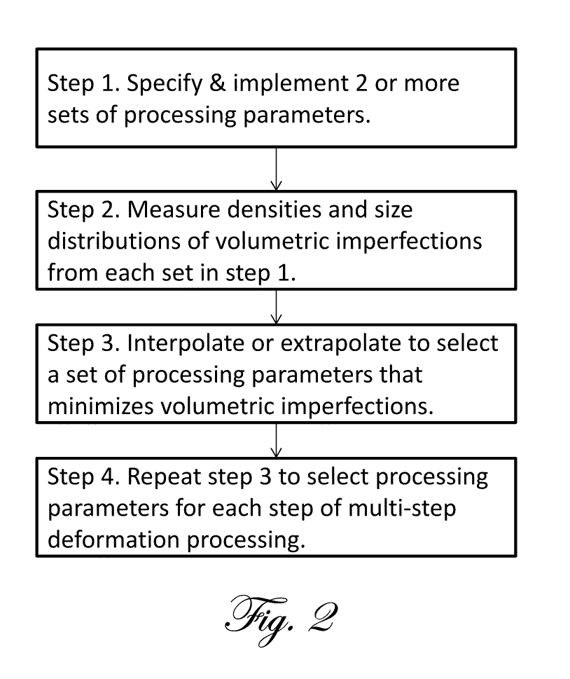

A methodology to design a SPD process to create a material with high strength levels through control of deformation-induced volumetric imperfections is outlined in the four steps below, and pictured graphically in sequence in FIG. 2.

Step 1. Select and implement two or more alternative sets of initial conditions and thermomechanical processing parameters in order to evaluate conditions that minimize the density and/or size of the concomitant DIVMI while maximizing the generation of DINVMI to resist inelastic deformation;
Step 2. Measure volumetric imperfection densities and size distributions associated with each set of alternative thermomechanical deformation processing parameters introduced in step 1 to quantify the relationship between the selection of initial conditions and processing parameters and the goal to minimize the density and/or size of DIVMI; and
Step 3. Interpolate or extrapolate the results of step 2 to select the initial condition and a set of thermomechanical deformation processing parameters that minimizes the density and/or size of the concomitant DIVMI while maximizing the generation of DINVMI obstacles to inelastic deformation.
Step 4. Select additional sets of thermomechanical deformation parameters to be used at different points during multi-step or multi-stage processing. Optimize the parameters for pre- and post-SPD treatments.

Step 4 can be particularly important since SPD processing typically involves iterative operations (e.g. as in the multiple passes employed in ECAP) and sometime multiple stages of metal treatment (e.g. pre-ECAP and post-ECAP thermomechanical treatments). The methodology of quantifying and minimizing the density and/or size of volumetric imperfections can be applied to adjust the processing conditions for any iteration or stage of thermomechanical deformation processing.

By understanding the principles underlying the 4 step method, it is possible to select initial conditions and processing parameters without the need for trial-and-error evaluations of alternate processing conditions, as proposed in Step 1 above. This methodology is explained next.

To maximize σ_{DINVMI} one wants to impose thermomechanical processing at the lowest possible temperature (to minimize recovery) and highest possible strain rate (to maximize manufacturing through put and economics), using any of SPD deformation schemes and die configurations, including those that are openly documented in the academic literature. Principles of equal-channel angular pressing as a processing tool for grain refinement; Ruslan Z. Valiev, Terence G. Langdon; 7, Amsterdam:Elsevier, 2006, Progress in Materials Science, Vol. 51, pp. 881-981; ISSN 0079-6425; The Art and Science of Tailoring Materials by Nanostructuring for Advanced Properties Using SPD Techniques; R. Z. Valiev, T. G. Langdon; 8, Weinheim:Verlog GmbH & Co., 2010, Vol. 12, pp. 677-691. One novel aspect of the present invention is the method of selecting the thermomechanical processing parameters to maximize σ_{DINVMI} based upon knowledge of Ø_{VNI}. The selection of the temperature and/or strain rate of deformation processing can be guided by a constraint that at no position in the work piece can there be a tensile stress state that would enlarge a critical-sized imperfection or propagate a crack from it. Before selecting specific thermomechanical processing parameters for a billet of a particular starting material, one can first measure Ø_{VMI} to determine the density and the maximum size of volumetric microstructural imperfections in the work piece. This allows one to determine the maximum flow stresses that can be sustained in a work piece without fracture. The maximum allowable stress can be determined from Equation 2. The highest local flow stress for a given shear strain rate and temperature can then be estimated from measurements or computational model predictions of the strain rate sensitivity and temperature dependence of plastic flow. Such measurements and models are openly understood (see for example Thermomechanical coupling simulation and experimental study in the isothermal ECAP processing of Ti-6Al-4V alloy; Miaoquan Li, Chen Zhang, Jiao Luo, and Mingwang Fu; 6, Berlin:Springer-Verlag, December 2010, Rare Metals, Vol. 29, pp. 613-620.) and not described in detail here. Computational model predictions can be preferred for estimating the maximum stress since this stress will invariably occur within a localized shear band, for which the shearing strain rate may be readily computed, but is difficult to measure. Note that the maximum strain rate can also be bounded by the effects of inelastic deformation-induced heating. Steps 1, 2, and 3 can be iterated if the initial choices of sets of processing parameters in Step 1 do not result in a clear trend for interpolation or extrapolation in Step 3.

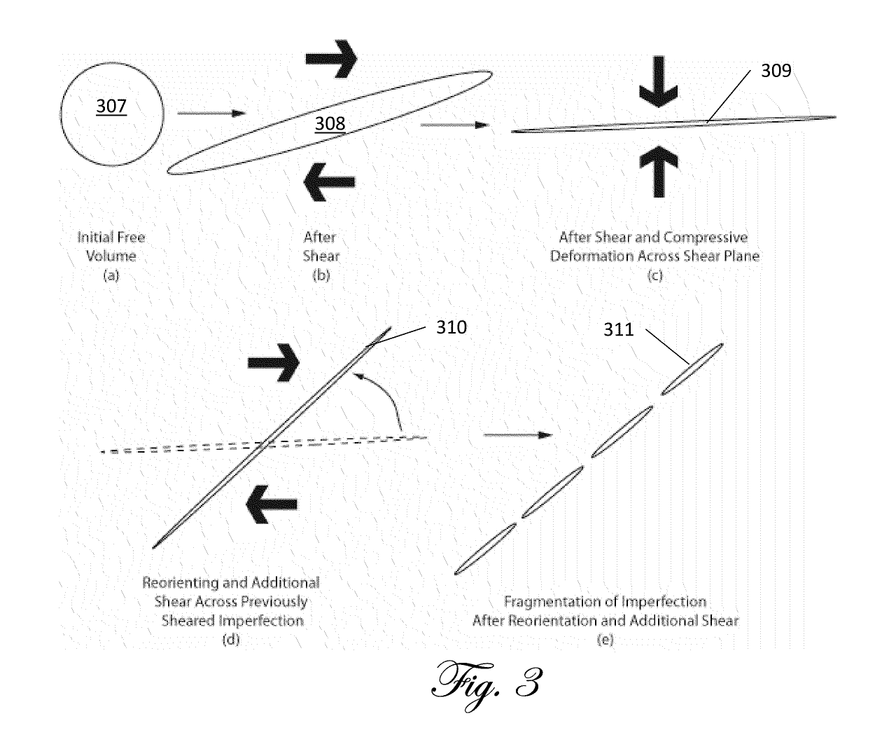

To achieve minimal Ø_{VMI} it can be important to impose thermomechanical processing conditions that reduce the size and density of pre-existing VMI and decrease the propensity for nucleation and growth of DIVMI. The size of pre-existing VMI is reduced when the intensity of shearing is maximized in the presence of high hydrostatic or compressive stress normal to the plane of shearing. Intense shearing elongates any volumetric imperfections, re-orienting them toward the shear plane, while superimposed compressive stresses causes closure of free volume or reinforces interfacial bonding with second phases. FIG. 3 illustrates how intense shear can cause shrinkage of VMI. FIG. 3 is a schematic illustration of intense shear changing an initially spherical void 307 (a) into an ellipsoidal shape 308 (b) that can more readily collapse under compressive stress 309 (c) or be subdivided by subsequent intense shearing following reorientation 310 out of the original shearing plane (d) to create smaller free volumes 311 (e).

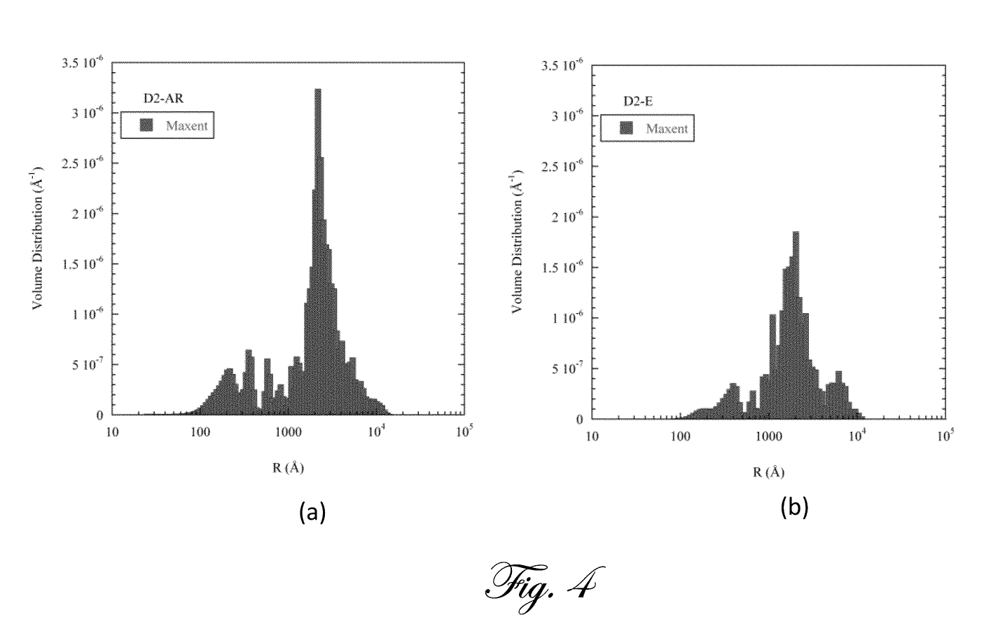

FIG. 4 is an illustration of Ultra Small Angle Neutron Scattering measurements of volumetric imperfection size distributions in commercial purity Grade 2 titanium: (a) as-received (D2-AR), (b) after ECAP (D2-E). The imperfection density and average size decrease after ECAP. The result of an example of application of the method is shown in FIG. 4. In this example, a 12 mm diameter billet of Grade 2 commercially pure titanium was subject to SPD via 8 passes of ECAP, rotating the billet 90 degrees clockwise after each pass. The initial density and size distribution of volumetric imperfections was measured via Ultra Small Angle Neutron Scattering. This sample is designated D2-AR. The measured Ø_{VMI} is shown in FIG. 4(a). The largest volumetric imperfections measured have a radius of 1.4 micrometers. Using equation 2, one computes a critical stress level of 479 MPa, which corresponds with the flow stresses levels computed in titanium during processing at temperatures between 200 C to 250 C. Accordingly, ECAP was conducted at 200 C. The measurement of Ø_{VMI} after ECAP is shown in FIG. 4(b). The average size of volumetric imperfection shifts from 396 nm to 378 nm and the measured total density of imperfections from the Ø_{VMI} function decreases from 0.0064 to 0.0044. The maximum size of imperfection after ECAP is reduced only slightly, in this case to 1.2 microns.

Table 1 shows the densities of volumetric imperfections within specific size ranges for initial condition (D2-AR) and after ECAP-processing (D2-E). The volume fractions of imperfections are reduced by the ECAP in all size ranges. The selection of 200 C for ECAP processing resulted in a desirable microstructure.

TABLE 1
Volume fractions for specific size ranges of free
volumes associated with imperfections before and
after ECAP of commercial purity titanium

| | Free Volume Fractions for Imperfections within Size Ranges | | | |
|---|---|---|---|---|
| Condition | 0.5-30.0 nm | 30.1-70.0 nm | 70.1-400 nm | >400 nm |
| As | 5.68 × 10⁻⁵ | 1.14 × 10⁻⁴ | 3.60 × 10⁻³ | 2.30 × 10⁻³ |
| received | | | | |
| After | 1.68 × 10⁻⁵ | 7.74 × 10⁻⁵ | 2.60 × 10⁻³ | 1.70 × 10⁻³ |
| ECAP | | | | |

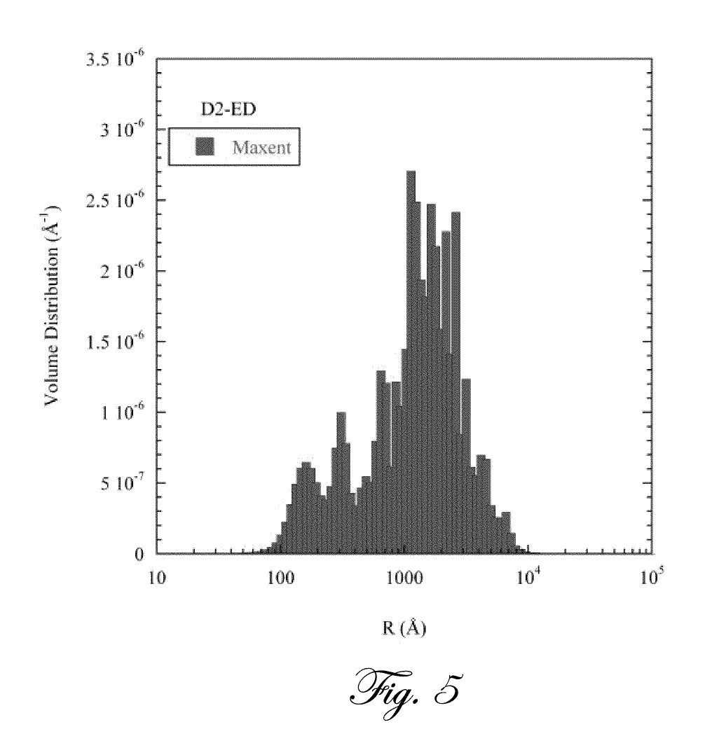

In contrast to the reductions in density of volumetric imperfections caused by ECAP, when deformation of the ECAPed work piece was continued via conventional drawing at 150 C to reduce the cross section by 74%, one measures an increase in Ø_{VMI}, as seen in FIG. 5 and Table 2. FIG. 5 is an illustration of Ultra Small Angle Neutron Scattering measurements of volumetric imperfection size distributions in commercial purity Grade 2 titanium after ECAP and 74% reduction via drawing. The imperfection density increases and average imperfection size decreases.

TABLE 2
Volume fractions for specific size ranges of free
volumes associated with imperfections after ECAP +
drawing of commercial purity titanium

| | Free Volume Fractions for Imperfections within Size Ranges | | | |
|---|---|---|---|---|
| Condition | 0.5-30.0 nm | 30.1-70.0 nm | 70.1-400 nm | >400 nm |
| ECAP + | 8.95 × 10⁻⁵ | 2.43 × 10⁻⁴ | 4.90 × 10⁻³ | 1.50 × 10⁻³ |
| drawing | | | | |

The higher stresses present during conventional drawing, in combination with the absence of localized shear under pressure, causes increases in the densities of imperfections in three of the four size ranges. One can conclude that the post-ECAP deformation needs to be conducted at a higher temperature or using a deformation scheme that imposes more compressive or hydrostatic stress. Accordingly, by choosing a new set of processing parameters (step 1) and re-measuring imperfections (step 2) one can further optimize the microstructure to minimize the imperfection size and density. The steps of the method can be performed iteratively.

From the SANS and USANS data shown in FIG. 4 and Table 1 it can been seen that SPD can have three significant positive effects upon the microstructures of metals and alloys:

1) the average size of volumetric imperfections can become smaller,
2) the volume fraction of the largest size volumetric imperfection can decrease, and
3) the volume fraction of the smallest size imperfections may increase or decrease.
The shift in size distribution can include an increase the volume fraction of the smallest imperfections at the expense of the larger imperfections. This may occur by localized shearing of larger imperfections into smaller imperfections. The reduction of the size and density of volumetric microstructural imperfections reduces the presence of imperfections that can act as sites for initiating fracture or fatigue failure.

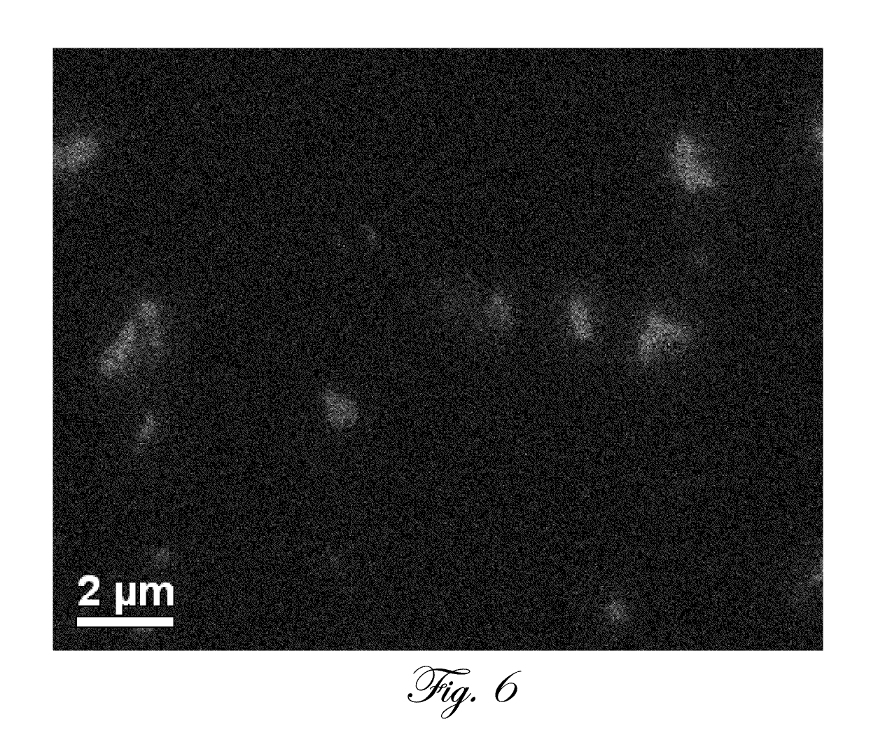

The volumetric imperfections detected by SANS of titanium can be imaged directly using electron microscopy. FIG. 6 is a scanning electron microscope image of the distribution of iron in ultrafine grained grade 4 titanium. Volumetric imperfections associated with iron range in size between 200 nm and 1100 nm. The electron micrograph in FIG. 6 shows a 21,000 times magnification of Grade 4 titanium after ECAP in which one can see the presence of iron clusters. The clusters range in size from 200 nm to 1100 nm. Imaging by electron microscopy compliments the quantitative analysis of imperfections by SANS by providing qualitative data on the spatial distribution of imperfections. Such images are helpful for displaying the spatial distribution and gradients of density, size, and shape of volumetric imperfections.

The present invention has been described in the context of various example embodiments as set forth herein. It will be understood that the above description is merely illustrative of the applications of the principles of the present invention, the scope of which is to be determined by the claims viewed in light of the specification. Other variants and modifications of the invention will be apparent to those of skill in the art.

What is claimed is:

1. A metal or alloy object, comprising a rod, sheet, bar, plate, wire, or other shape which has been produced using severe plastic deformation processing to reduce the density of volumetric deformation induced microstructural imperfections.

2. A metal or alloy object as in claim 1 in which the maximum size, average size, or both, of deformation-induced volumetric microstructural imperfections is shifted to smaller values.

3. A metal or alloy object as in claim 1 in which the ratio of the maximum to minimum linear dimensions deformation-induced volumetric microstructural imperfections is maintained or shifted toward unity (1).

4. A metal or alloy object as in claim 1 in which spatial gradients in the density of deformation-induced volumetric microstructural imperfections are maintained or shifted to correspond with gradients in the density of non-volumetric deformation induced microstructural imperfections.

5. A metal or alloy object as in claim 1 in which spatial gradients in the density of deformation-induced volumetric microstructural imperfections are maintained or shifted to not be steeper than gradients in the density of non-volumetric deformation induced microstructural imperfections.

6. A metal or alloy object as in claim 1 in which spatial gradients in the size distribution of deformation-induced volumetric microstructural imperfections are maintained or shifted to not be steeper than gradients in the density of non-volumetric deformation induced microstructural imperfections.

7. A metal or alloy object as in claim 1 in which spatial gradients in the asymmetry of shape of deformation-induced volumetric microstructural imperfections, that is, the ratio of maximum to minimum linear dimensions, are maintained or shifted to not be steeper than gradients in the density of non-volumetric deformation induced microstructural imperfections.

8. A method to improve the strength of metals and alloys comprising measuring the density and size distribution of deformation-induced volumetric microstructural imperfections and determining processing parameters based on such measurements.

9. A method as in claim 8, wherein the measurement technique includes the use of Small Angle Neutron Scattering.

10. A method as in claim 8, wherein the measurement technique includes the use of Small Angle X-ray Scattering.

11. A method as in claim 8, wherein the measurement technique includes the use of Positron Lifetime Spectroscopy.

12. A method as in claim 8, wherein the measurement technique includes the use of electron microscopy imaging.

13. A method to improve the strength of metals and alloys by controlling the density and size distribution of deformation-induced volumetric microstructural imperfections.

14. A method as in claim 13, wherein the size distribution of deformation-induced volumetric microstructural imperfections is maintained or shifted to smaller sizes.

15. A method as in claim 13, wherein the temperature and rate of severe plastic deformation are specified to minimize the density of deformation-induced volumetric microstructural imperfections.

16. A method as in claim 13, wherein imperfection control is achieved through implementation of specific features in the design of the apparatus for SPD processing to maximize the intensity of localized shearing, which features include deformation schema and die characteristics that maximize shearing.

17. A method as in claim 16, comprising Equal Channel Angular Pressing, using die angles of 90 degrees or more, with zero radius of curvature inner and outer radii at channel intersections.

18. A method as in claim 13, wherein a specific combination of thermomechanical processing steps and parameters are utilized, guided by criteria that cause the reduction of the density and size of deformation-induced volumetric imperfections.

19. A method as in claim 13, wherein the quantitative measurements of imperfection density and size distribution are employed to measure or verify processing results, including, but not limited to one or more of the following techniques: Small Angle Neutron Scattering, Ultra Small Angle Neutron Scattering, Small Angle X-ray Scattering (SAXS), Ultra Small Angle X-ray Scattering, Positron Lifetime Spectroscopy, X-ray Profile Analysis (XPA), Multi Reflection Multi-line X-ray Profile Analysis (MXPA), Residual Electrical Resistometry (RER), Electron Microscopy (EM), X-ray Micro-Tomography (XMT), X-ray Nanoscale Tomography (XNT), X-Ray Coherent Diffraction Imaging (XCDI), Electron Microscopy Tomography (EMT), Electron Coherent Diffraction Imaging (ECDI), Neutron Tomography (NT), and Positron Tomography (PT).
